(19) United States
(12) Patent Application Publication
(10) Pub. No.: US 2009/0204730 A1
(43) Pub. Date: Aug. 13, 2009

(54) MANUAL PROVISION METHOD, PERIPHERAL DEVICE, AND CONTROL PROGRAM

(75) Inventor: Takatoshi Mochizuki, Kobe-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 12/365,925

(22) Filed: Feb. 5, 2009

(30) Foreign Application Priority Data
Feb. 12, 2008 (JP) 2008-030230

(51) Int. Cl. G06F 3/00

(52) U.S. Cl. 710/19; 710/1

(57) ABSTRACT

A terminal device used by a user transmits identification information on an application used along with a multi-function peripheral by the terminal device to that multi-function peripheral. The multi-function peripheral then transmits, to the terminal device, for-display manual data on a manual corresponding to the application indicated by the identification information received from the terminal device.

This application is based on Japanese Patent Application No. 2008-030230 filed on Feb. 12, 2008, the contents of which are hereby incorporated by reference.

### BACKGROUND OF THE INVENTION

1. Field of the Invention

The present invention relates to a method for providing, to a user, a manual for a peripheral device used with a personal computer or the like.

2. Description of the Related Art

At present, various peripheral devices, such as printers, card readers, multi-function peripherals, and so on, are being used with personal computers.

Manuals for such peripheral devices are provided to users in printed form, as manual booklets, or are recorded onto an electronic medium such as a CD-ROM and provided to users in electronic form. Manuals are also sometimes provided through the manufacturer's web site. Manuals provided through electronic media or web sites are generally called “electronic manuals”.

Compared to providing users with manuals in booklet form, providing manuals as electronic manuals is advantageous for users in the following ways.

First, electronic manuals allow a user to use his/her personal computer to search for a desired item by using a term relating to that item as a keyword and searching for parts of the manual corresponding to that keyword. Even if the user only knows part of the term s/he is searching for, s/he can use fuzzy matching functions to search for the necessary items. Meanwhile, with manuals in booklet form, users can utilize the table of contents or the index to search for parts of the manual that include the items they desire. However, with manual booklets, there are situations where it is difficult for the user to find the desired items, such as when the table of contents or index lacks sufficient depth, the user only knows part of the desired term, and so on.

Electronic manuals further make it possible to significantly reduce the amount of physical space required to store the manual, as compared to manual booklets.

Employing electronic manuals is also advantageous for manufacturers, as it allows them to reduce the amount of packaging of the peripheral device, and also reduces costs. Furthermore, electronic manuals facilitate the conservation of paper resources, making them more environmentally friendly.

It is for such reasons that recent years have seen a major shift from manual booklets to electronic manuals. Accordingly, various proposals are being made to make electronic manuals even more user-friendly.

According to the method of Patent Document 1 (JP H09-163060A), upon an instruction to display help information being made through the operational panel of a facsimile device, history information regarding the operations made up until that point in time is edited, and an operation manual is created based on the edited operation history information.

Furthermore, according to Patent Document 2 (JP 2003-84954A), upon a user requesting an electronic manual of a printer to be displayed, content is first displayed based on the status of the printer, the amount of time that has passed since the printer drivers were installed, the season, the amount of time for which the printer has not been used, and so on.

Meanwhile, in recent years, the functions of peripheral devices and the functions of personal computer are being applied in various combinations, thereby providing various services to users.

For example, installing the application disclosed in Non-Patent Document 1 (Konica Minolta's “PageScope Workware”, found at http://konicaminolta.jp/business/products/software/document_management/workware/pdf/workware.pdf) in a personal computer and using the application makes it possible to obtain image data on a document through a scanning function of a multi-function peripheral and edit that document using an editor function in the personal computer. The edited document can furthermore be printed using a printing function of the multi-function peripheral.

Manuals for such applications are also provided to users. Therefore, manuals for the peripheral device, the personal computer, and the application are all provided to users.

However, when using such an application to alter settings in the multi-function peripheral, cause the multi-function peripheral to execute processes, and so on, the user is required to refer not only to the manual for the application itself, but also to the manual for the multi-function peripheral.

Referring to two different manuals is troublesome for the user. Furthermore, recent years have seen an increase in the functions provided by multi-function peripherals and applications, which has led to an increase in the size of manuals. Therefore, it is becoming increasingly difficult to find desired items in manuals, even if those manuals are electronic manuals.

### SUMMARY

Having been conceived in light of the aforementioned problems, it is an object of the present invention to make it easier for a user of a multi-function peripheral and an application to find a desired item within a manual than was conventionally possible.

A manual provision method according to a first aspect of the present invention is a manual provision method for providing a manual of a peripheral device to a user. The method includes a first step of causing a computer used by the user to transmit, to the peripheral device, application identification information on an application used along with the peripheral device by the computer, and a second step of causing the peripheral device to transmit, to the computer, content data indicating content of the manual that corresponds to the application indicated by the application identification information received from the computer.

A manual provision method according to a second aspect of the present invention is a manual provision method for providing a manual of a peripheral device to a user, wherein a saving portion that saves, per group that configures the manual, content data indicating content of the group in association with content data identification information on the content data, and a storage portion that stores the content data identification information on the content data in association with application identification information on an application used along with the peripheral device by a terminal device corresponding to the content data, are provided in a server connectable to the peripheral device via a communication line. The method includes a first step of causing a terminal device used by the user to transmit, to the peripheral device, application identification information on an application used along with the peripheral device by the terminal device, a second step of causing the peripheral device to transmit, to the server, the application identification information received from the terminal device, a third step of causing the server to transmit, to the peripheral device, the content data saved in the saving portion in association with the content data identification information stored in the storage portion in association with the application identification information received from the peripheral device, and a fourth step of causing the peripheral device to transmit, to the terminal device, the content data received from the server.

A manual provision method according to a third aspect of the present invention is a manual provision method for providing a manual of a peripheral device to a user. The method includes a first step of causing the peripheral device to determine the current status of the peripheral device itself, and a second step of causing the peripheral device to transmit, to a computer used by the user, content data on the manual corresponding to the current status of the peripheral device itself as determined in the first step.

A manual provision method according to a fourth aspect of the present invention is a manual provision method for providing a manual of a peripheral device to a user, wherein a saving portion that saves, per group that configures the manual, content data indicating content of the group in association with content data identification information on the content data, and a storage portion that stores the content data identification information on the content data in association with a status of the peripheral device that corresponds to the content data, are provided in a server connectable to the peripheral device via a communication line. The method includes a first step of causing the peripheral device to determine the current status of the peripheral device itself, a second step of causing the peripheral device to notify the server of the current status of the peripheral device itself as determined in the first step, a third step of causing the server to transmit, to the peripheral device, the content data saved in the saving portion in association with the content data identification information stored in the storage portion in association with the current status as notified by the peripheral device, and a fourth step of causing the peripheral device to transmit, to a computer used by the user, the content data received from the server.

According to the present invention, a user that operates an application that runs by accessing a multi-function peripheral can easily refer to a desired item in a manual.

### BRIEF DESCRIPTION OF THE DRAWINGS

FIG. 1 is a diagram showing an example of the overall configuration of a network system.

FIG. 2 is a diagram illustrating an example of a hardware configuration of a multi-function peripheral.

FIG. 3 is a diagram showing an example of the functional configuration of a multi-function peripheral.

FIG. 4 is a diagram illustrating an example of a hardware configuration of a terminal device.

FIG. 5 is a diagram showing an example of the functional configuration of a terminal device.

FIG. 6 is a diagram illustrating an example of a content page correspondence table.

FIG. 7 is a diagram illustrating an example of a content publication settings table.

FIG. 8 is a flowchart which illustrates the overall flow of processing performed by a terminal device.

FIG. 9 is a diagram illustrating an example of a screen showing a list of multi-function peripherals that can be connected to.

FIG. 10 is a flowchart which illustrates the overall flow of processing performed by a multi-function peripheral.

FIG. 11 is a flowchart illustrating an example of the flow of processing for requesting, generating, and distributing a manual.

FIG. 12 is a diagram illustrating an example of a screen showing a table of contents of a manual.

FIG. 13 is a diagram illustrating an example of the overall configuration of a network system.

FIG. 14 is a diagram showing an example of the functional configuration of a multi-function peripheral.

FIG. 15 is a diagram illustrating an example of the functional configuration of a manual management server.

FIG. 16 is a flowchart illustrating an example of the flow of processing for requesting, generating, and distributing a manual.

### DESCRIPTION OF THE PREFERRED EMBODIMENTS

### First Embodiment

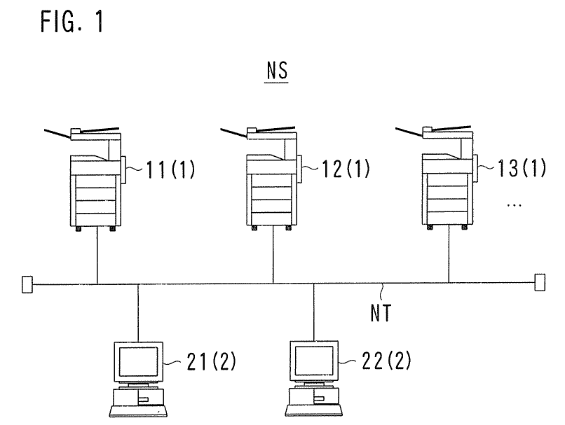

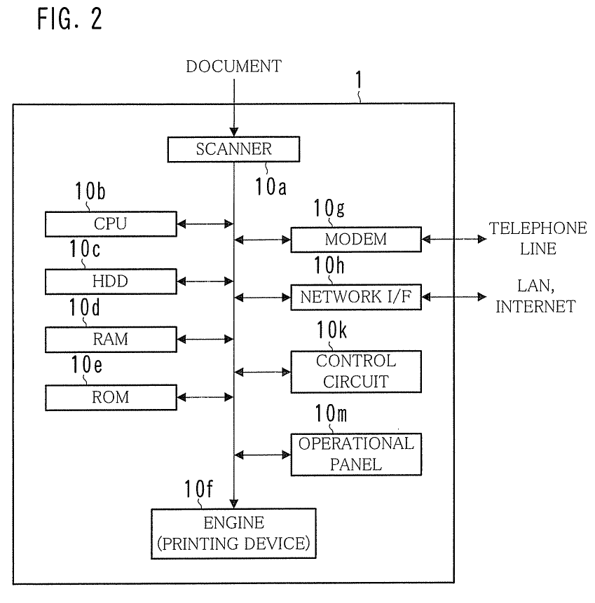

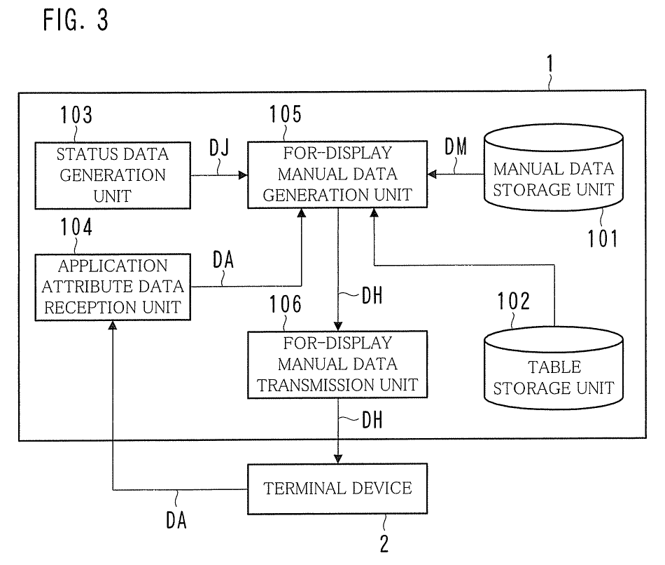

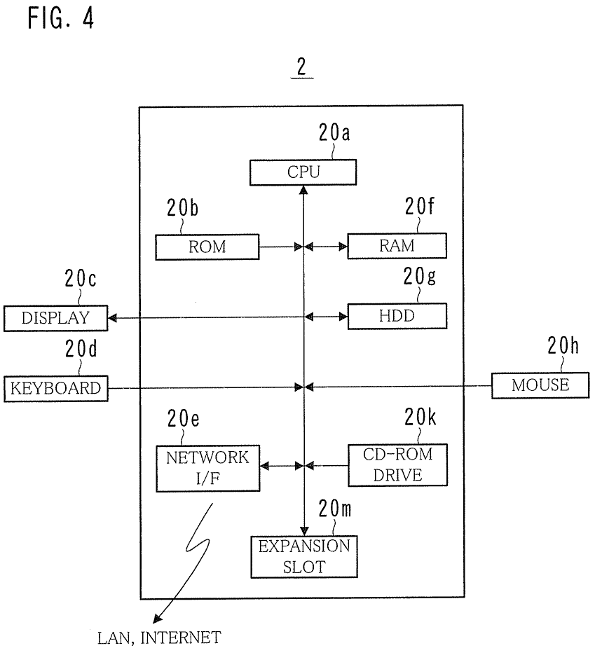

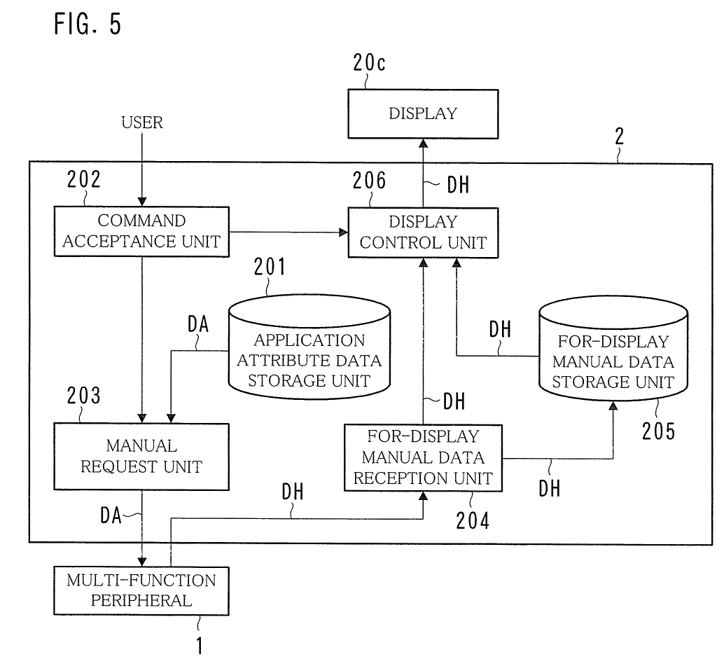

FIG. 1 is a diagram showing an example of the overall configuration of a network system NS; FIG. 2 is a diagram illustrating an example of a hardware configuration of a multi-function peripheral 1; FIG. 3 is a diagram showing an example of the functional configuration of the multi-function peripheral 1; FIG. 4 is a diagram illustrating an example of a hardware configuration of a terminal device 2; and FIG. 5 is a diagram showing an example of the functional configuration of the terminal device 2.

The network system NS is configured of multi-function peripherals 11, 12, and so on; terminal devices 21, 22, and so on; and a communication line NT. The multi-function peripherals 11, 12, and so on may be collectively referred to as a “multi-function peripheral 1” hereinafter. Similarly, the terminal devices 21, 22, and so on may be collectively referred to as a “terminal device 2” hereinafter. Other devices, data, or the like may also be collectively described in the same manner, with their sequential reference numerals being omitted.

The multi-function peripheral 1 and the terminal device 2 are connected to one another via the communication line NT. A LAN, WAN, the Internet, an intranet, a dedicated line, or the like may be used as the communication line NT.

The multi-function peripheral 1 is a device that integrates a variety of functions, such as copying, network scanning, faxing, network printing, file transferring, box functions, and so on, into a single unit. Multi-function peripherals are also sometimes abbreviated as “MFPs”.

The stated “network scanning” function refers to a function for transmitting image data obtained through scanning performed by a scanner to another device via a communication line.

The stated “box function”, meanwhile, refers to an application function where “boxes” or “personal boxes”, which are storage areas corresponding to folders or directories in a personal computer, are allocated in a hard disk on a user-by-user basis, and image data obtained through scanner operations and the like is saved to a user's own storage region. The box function is also sometimes called a “document server function”.

As shown in FIG. 2, the multi-function peripheral 1 is configured of a scanner 10a, a Central Processing Unit (CPU) 10b, a hard disk 10c, a Random Access Memory (RAM) 10d, a Read-Only Memory (ROM) 10e, a printing device 10f, a modem 10g, a network interface 10h, a control circuit 10k, an operational panel 10m, and so on. Note, however, that the hard disk 10c and the modem 10g are optional elements. There are therefore multi-function peripherals 1 that are not provided with the hard disk 10c, the modem 10g, or either elements.

The scanner 10a is a device that optically reads images rendered upon paper documents, such as photographs, characters, drawings, diagrams, and the like, and creates digitized data therefrom.

The printing device 10f is a device that prints the image data scanned by the scanner 10a or the image data transmitted from the terminal device 2 onto paper using yellow, magenta, cyan, and black toners.

The operational panel 10m is a device used by the user to provide instructions to the multi-function peripheral 1. The operational panel 10m is provided with a display unit, in which messages to the user, screens used for making various settings, and so on are displayed. The user can also provide instructions to the multi-function peripheral 1 remotely by operating the terminal device 2.

Note that the network system NS may include both multi-function peripherals 1 that allow use only when user authentication is carried out and the authenticity of the user is confirmed, and multi-function peripherals 1 that allow use without user authentication. Hereinafter, a multi-function peripheral 1 that carries out user authentication shall be referred to as a “multi-function peripheral 1 with an authentication mode” or the like, whereas a multi-function peripheral 1 that does not carry out user authentication shall be referred to as a “multi-function peripheral 1 without an authentication mode” or the like.

The CPU 10b performs overall control of the multi-function peripheral 1. The modem 10g includes a Network Control Unit (NCU), and connects to another fax terminal via an analog public line, performing data control based on facsimile protocols, modulation/demodulation of fax data, and so on. The network interface 10h is a Network Interface Card (NIC), and is an interface for connecting to another device, such as the terminal device 2, via a LAN, the Internet, or the like.

The control circuit 10k is a circuit for controlling devices such as the hard disk 10c, the operational panel 10m, the scanner 10a, the printing device 10f, the modem 10g, and the network interface 10h.

The ROM 10e or the hard disk 10c stores programs, data, and so on for realizing a manual data storage unit 101, a table storage unit 102, a status data generation unit 103, an application attribute data reception unit 104, a for-display manual data generation unit 105, and a for-display manual data transmission unit 106, as shown in FIG. 3. These programs and data are loaded into the RAM 10d as necessary, whereupon the programs are executed by the CPU 10b. Alternatively, some or all of the elements shown in FIG. 3 may be implemented solely by hardware such as the control circuit 10k.

Note that, as described above, the network system NS may include multi-function peripherals 1 provided with both the hard disk 10c and the modem 10g, multi-function peripherals 1 provided with either of those elements, and multi-function peripherals 1 provided with neither of those elements. Furthermore, while there are multi-function peripherals 1 with authentication modes, there are also multi-function peripherals 1 without authentication modes. In addition, the network system NS also includes multi-function peripherals 1 that prohibit certain specific operations. For example, there are multi-function peripherals 1 that prohibit operations for downloading color image data (color data). Operations that are prohibited shall be referred to as “prohibited operations” hereinafter.

Using the various elements shown in FIG. 3, the manual of the multi-function peripheral 1 can be provided to the terminal device 2. This shall be described in detail later.

The terminal device 2 is a personal computer, a workstation, or the like. As shown in FIG. 4, the terminal device 2 is configured of a CPU 20a, a ROM 20b, a display 20c, a keyboard 20d, a network interface 20e, a RAM 20f, a hard disk 20g, a mouse 20h, a CD-ROM drive 20k, an expansion slot 20m, and so on.

Various applications for performing processes in cooperation with the multi-function peripheral 1 are installed in the ROM 20b or the hard disk 20g. Using these applications, the user can download data saved in the multi-function peripheral 1 to the terminal device 2 and use the data, cause the multi-function peripheral 1 to print documents, cause the multi-function peripheral 1 to scan documents, and so on. An application for performing settings for the multi-function peripheral 1 is also installed in the ROM 20b or the hard disk 20g.

Hereinafter, such applications for performing processes cooperatively with the multi-function peripheral 1 or for performing settings for the multi-function peripheral 1 shall be referred to as “cooperative applications”.

Programs and data for implementing an application attribute data storage unit 201, a command acceptance unit 202, a manual requesting unit 203, a for-display manual data reception unit 204, a for-display manual data storage unit 205, a display control unit 206, and the like, as shown in FIG. 5, are furthermore installed in the ROM 20b and the hard disk 20g. These programs and data are loaded into the RAM 20f as necessary, whereupon the programs are executed by the CPU 20a.

Using the various elements shown in FIG. 5, the data on the manual of the multi-function peripheral 1 can be acquired from the multi-function peripheral 1 and used. This shall be described in detail later. Note that the data on the manuals of the cooperative applications is installed in the hard disk 20g of the terminal device 2. Alternatively, this data can be loaded from the CD-ROM using the CD-ROM drive 20k.

The network interface 20e is an interface for carrying out communication with another device. An NIC, a modem, or the like is used as the network interface 20e.

The display 20c is a CRT display, a liquid-crystal display, or the like. The keyboard 20d and mouse 20h are input devices manipulated by the user in order to provide commands to the terminal device 2. The CD-ROM drive 20k is a device for loading data stored in a CD-ROM. The expansion slot 20m is an insertion slot for mounting an interface board used for functional expansion.

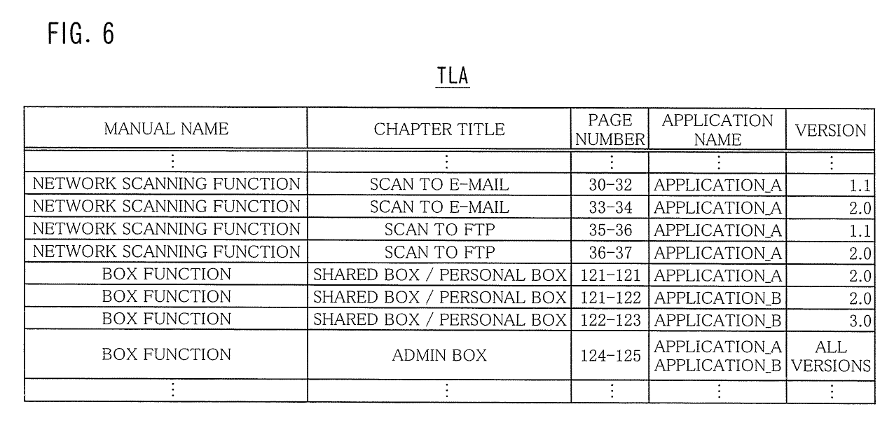

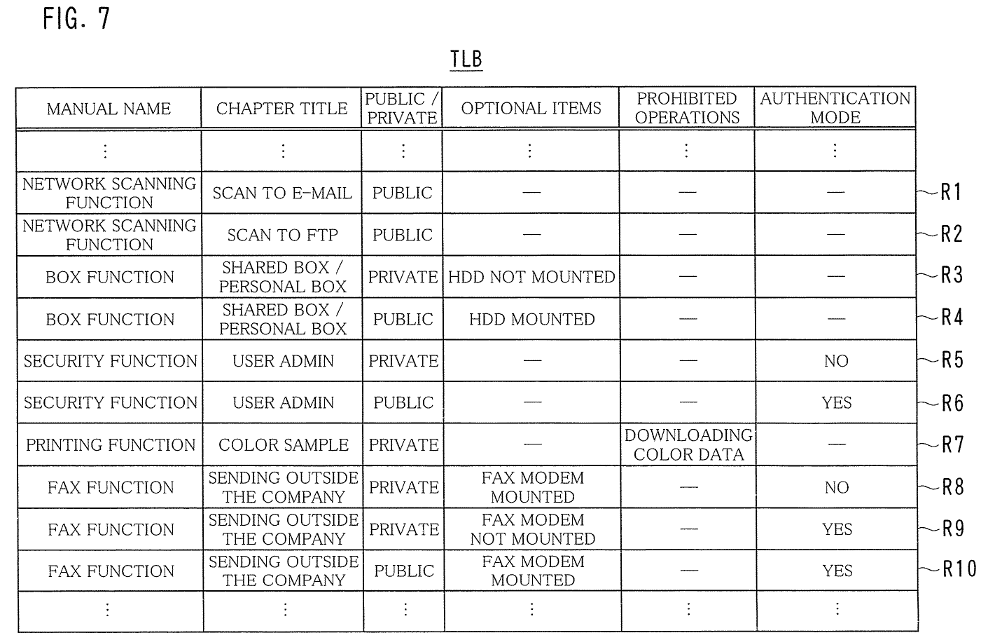

FIG. 6 is a diagram illustrating an example of a content page correspondence table TLA, and FIG. 7 is a diagram illustrating an example of a content publication settings table TLB.

Next, the details of processing performed by each of the constituent elements of the multi-function peripheral 1 shown in FIG. 3 and the constituent elements of the terminal device 2 shown in FIG. 5 shall be described in detail.

The manual data storage unit 101 of the multi-function peripheral 1 as shown in FIG. 3 stores manual data DM for displaying or printing the manual of the multi-function peripheral 1 itself. Portable Document Format (PDF), HyperText Markup Language (HTML), or the like is used as the format of the manual data DM.

The table storage unit 102 stores the content page correspondence table TLA and the content publication settings table TLB.

Meanwhile, as described earlier, the multi-function peripheral 1 is provided with various functions, such as a network scanning function, a box function, and so on. The exemplary functions mentioned earlier cover broad concepts of functions, which is to say that the aforementioned functions include plural specific functions therewithin. For example, the network scanning function includes such specific functions as “Scan to E-mail”, “Scan to FTP”, and so on. The “Scan to E-mail” function is a function that attaches image data acquired through the scanner 10a to an e-mail and transmits that e-mail to another device. Meanwhile, the “Scan to FTP” function is a function that transmits image data acquired through the scanner 10a to another device using the File Transfer Protocol (FTP).

Hereinafter, the functions that fall under broad concepts, such as the network scanning function and the box function, shall be referred to as “broad functions”, whereas the specific functions that make up the broad functions shall be referred to as “specific functions”.

Manuals are prepared for the multi-function peripheral 1 for each broad function. Therefore, manual data DM is stored in the manual data storage unit 101 for each of the broad functions.

Each of these manuals is made up of a plurality of pages. These pages are divided into chapters, with a chapter being allocated to each specific function. Furthermore, different content is prepared within the same chapter for each cooperative application usable with that specific function, or for each version.

For example, the specific function “shared box/personal box” within the broad function “box function” can be used with both versions 2.0 and 3.0 of a cooperative application “application_A”, and can furthermore be used with version 3.0 of a cooperative application “application_B”. Accordingly, content is prepared for each of the three combinations of cooperative applications and versions, as the content of chapters for the specific function. It should be noted that there are also situations where the same content is prepared in common for plural cooperative applications or plural versions.

The manual data DM is configured of chapter content data DS, prepared for each chapter as described thus far. Furthermore, as described above, chapter content data DS may be prepared within the same chapter for each cooperative application or version.

As shown in FIG. 6, the manual the content belongs to, the chapter the content belongs to, which cooperative application and which version of that application the content corresponds to, and the pages within the manual the content can be found on, are indicated in the content page correspondence table TLA within the table storage unit 102.

However, all the content in a given manual is not unconditionally made public to any user. For example, the content of some chapters may be made public to users only in the case where a predetermined condition is satisfied. Conversely, some content may be prevented from being made public when a predetermined condition is met.

Records indicating conditions regarding the publication of content for each chapter in a manual are stored in the content publication settings table TLB within the table storage unit 102, as shown in FIG. 7.

The “manual name” and “chapter title” indicate the name of the manual and the title of the chapter, respectively.

“Public/private”, “optional items”, “prohibited operation”, and “authentication mode” indicate conditions for publicizing or not publicizing (that is, making private) the content of that chapter of the manual in accordance with the status of the multi-function peripheral 1 itself. In other words, when the conditions indicated in the items “optional items”, “prohibited operation”, and “authentication mode” are satisfied, the content is made public or made private in accordance with the details indicated in the “public/private” column. However, the “−” mark indicates that the conditions of that item are not to be applied.

For example, the record R3, which is the third record in FIG. 7, indicates that the content of the chapter “shared box/personal box” in the “box function” manual is to be made private when the hard disk 10c is not mounted to the multi-function peripheral 1. Meanwhile, the record R4, which is the fourth record, indicates that the content of the chapter “shared box/personal box” in the “box function” manual is to be made public when the hard disk 10c is mounted to the multi-function peripheral 1. Furthermore, the record R5, which is the fifth record, indicates that the chapter “user management” in the “security functions” manual is to be made private when the multi-function peripheral 1 has an authentication mode.

The record R1, which is the first record, indicates that the chapter “Scan to E-mail” in the “network scanning function” manual is to be made public regardless of the status of the multi-function peripheral 1 (in other words, unconditionally).

Returning to FIG. 3, the status data generation unit 103 determines the current statuses of the hardware, settings, and mode of the multi-function peripheral 1 itself, and generates status data DJ indicating those statuses. To be more specific, the status data DJ indicates the optional items mounted to the multi-function peripheral 1 itself, any prohibited operations that may be set, and the presence/absence of an authentication mode.

The application attribute data reception unit 104 receives application attribute data DA, described later, from the terminal device 2.

The for-display manual data generation unit 105 generates data for displaying the content of some or all of the chapters of a manual requested by the user of the terminal device 2. Hereinafter, the data for displaying the content of some or all of the chapters shall be referred to as “for-display manual data DH”. The method of generation shall be described later.

The for-display manual data transmission unit 106 transmits the for-display manual data DH generated by the for-display manual data generation unit 105 to the terminal device 2 that transmitted the application attribute data DA.

In FIG. 5, the application attribute data storage unit 201 of the terminal device 2 stores, for each cooperative application installed in the terminal device 2 itself, application attribute data DA indicating identification information (such as, for example, an application name) and the version.

The command acceptance unit 202 accepts a command to download a manual from a cooperative application.

The manual requesting unit 203 requests the for-display manual data DH from the multi-function peripheral 1 in accordance with the command accepted by the command acceptance unit 202. At this time, the application attribute data DA on the cooperative application, which is the source of the command, is transmitted to the multi-function peripheral 1.

The for-display manual data reception unit 204 receives the for-display manual data DH requested by the manual requesting unit 203 from the multi-function peripheral 1. The received for-display manual data DH is stored in the for-display manual data storage unit 205.

The display control unit 206 displays the manual in the display 20c, either one page at a time or plural pages at a time, based on the for-display manual data DH stored in the for-display manual data storage unit 205.

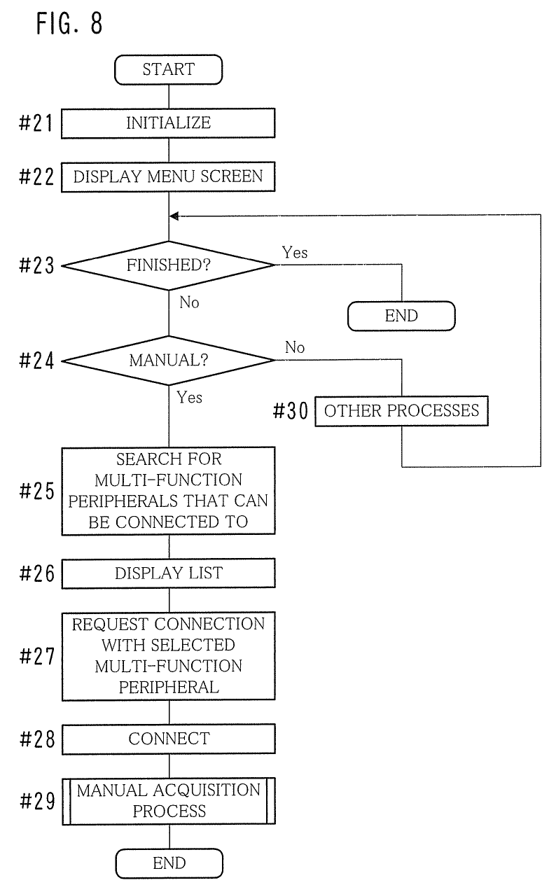

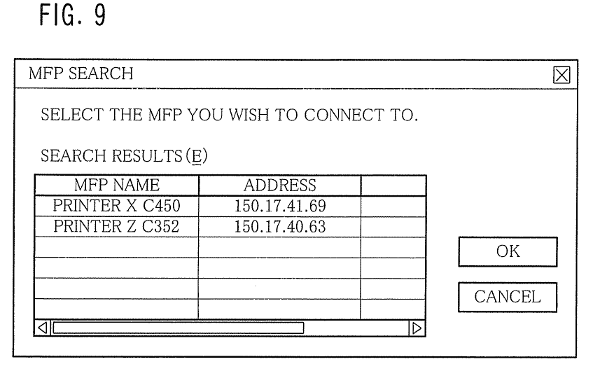

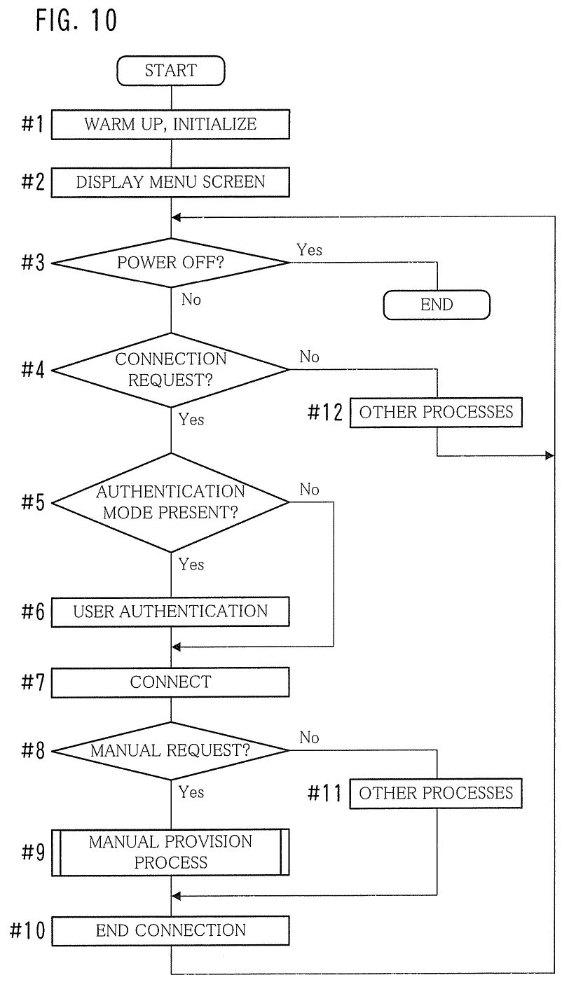

FIG. 8 is a flowchart which illustrates the overall flow of processing performed by the terminal device 2; FIG. 9 is a diagram illustrating an example of a screen showing a list of multi-function peripherals 1 that can be connected to; and FIG. 10 is a flowchart which illustrates the overall flow of processing performed by the multi-function peripheral 1.

Next, the processing routines performed by the cooperative applications, the various constituent elements of the multi-function peripheral 1 illustrated in FIG. 3, and the various constituent elements of the terminal device 2 indicated in FIG. 5 shall be described in detail with reference to the flowcharts in FIGS. 8 and 10.

In FIG. 8, when the user inputs a command to start up a cooperative application, the terminal device 2 starts up that cooperative application, and performs a process for initializing that cooperative application (#21). For example, the details set the previous time that cooperative application was terminated are reset, the variables used by the cooperative application are initialized, and so on.

The terminal device 2 then displays a menu screen of the cooperative application (#22). Here, the user can instruct the execution of various processes carried out in cooperation with the multi-function peripheral 1. Furthermore, the manual of the multi-function peripheral 1 can be displayed in the terminal device 2.

When the user inputs a command to display the manual (No in #23, Yes in #24), the terminal device 2 searches for multi-function peripherals 1 that can currently be connected to (#25), and a list of the multi-function peripherals 1 that have been found, as illustrated in FIG. 9, is displayed (#26).

When the user selects one of the multi-function peripherals 1 from the list, a connection request is made to that multi-function peripheral 1 (#27). At this time, there are cases where the multi-function peripheral 1 requests a user ID and a password in order to carry out user authentication. In such a case, the user is prompted to input his/her own user ID and password, which are then transmitted to the multi-function peripheral 1.

Upon a successful connection to the multi-function peripheral 1 (#28), the constituent elements illustrated in FIG. 5 are started up, and a command to execute a process for acquiring the manual of the cooperative application and displaying that manual is provided to the command acceptance unit 202 (#29). This process shall be described later.

Meanwhile, upon being turned on, the multi-function peripheral 1 warms up, and then carries out an initialization process (#1 in FIG. 10). A menu screen is displayed, and while the power is on, the multi-function peripheral 1 continuously stands by for a command from a user or from the terminal device 2 (#2).

Upon receiving a connection request from the terminal device 2 (Yes in #4), if the multi-function peripheral 1 itself has an authentication mode (Yes in #5), the multi-function peripheral 1 acquires a user ID and a password from the terminal device 2, and authenticates the user (#6). If the user authentication is successful, the connection with the terminal device 2 is completed (#7). If, however, the multi-function peripheral 1 does not have an authentication mode (No in #5), the connection with the terminal device 2 is completed (#7) without authenticating the user. The connection is of course terminated if the user authentication is unsuccessful.

If a command to transmit a manual has been received from the terminal device 2 (Yes in #8), a process for providing the manual to the terminal device 2 is carried out (#9). This process shall be described later.

Meanwhile, if a command aside from a command to transmit a manual has been received from the terminal device 2 (No in #8), a process appropriate for that command is carried out (#11). Also, if in Step #4 a command has been inputted using the operational panel 10m (No in #4), a process appropriate for that command is carried out (#12).

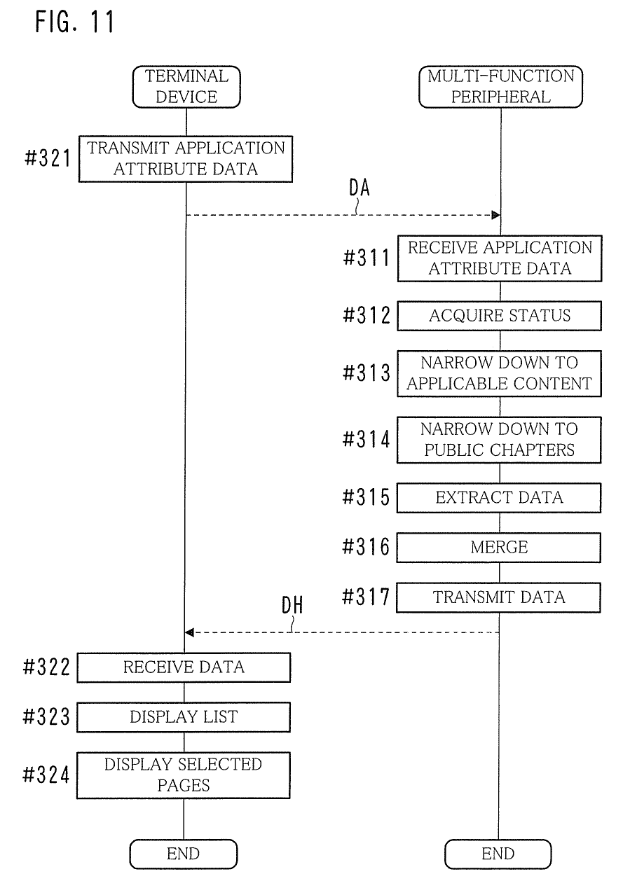

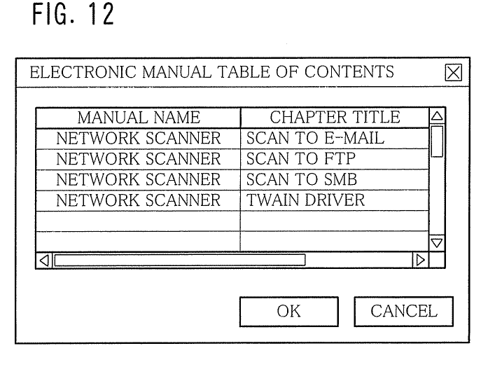

FIG. 11 is a flowchart illustrating an example of the flow of processing for requesting, generating, and distributing a manual, and FIG. 12 is a diagram illustrating an example of a screen showing a table of contents of a manual.

Next, a process performed by the terminal device 2 for acquiring and displaying a manual of a cooperative application, and a process performed by the multi-function peripheral 1 for providing the manual, shall be described with reference to FIG. 11.

Upon accepting a command to acquire and display a manual from the cooperative application, the command acceptance unit 202 retrieves the application attribute data DA on that cooperative application from the application attribute data storage unit 201, and transmits that data to the multi-function peripheral 1 selected by the user (#321).

When the application attribute data reception unit 104 of the multi-function peripheral 1 receives the application attribute data DA (#311), the for-display manual data generation unit 105 generates, in cooperation with the status data generation unit 103, the for-display manual data DH based on the application attribute data DA, the content page correspondence table TLA stored in the table storage unit 102 (see FIG. 6), and the content publication settings table TLB (see FIG. 7), in the manner described hereinafter (#312 to #316).

First, the status data generation unit 103 generates the status data DJ indicating the current statuses of the multi-function peripheral 1 itself (#312).

The record indicating the application name and version shown in the application attribute data DA is searched for within the content page correspondence table TLA (#313). This narrows the content down from the general content that makes up the entire manual to the specific content that applies to the cooperative application currently used by the user of the terminal device 2.

Whether or not to make the narrowed-down content public is determined based on the status data DJ and the content publication settings table TLB. As described earlier, whether to make the various chapters of each manual public or private depending on the statuses of the multi-function peripheral 1 is set in each record of the content publication settings table TLB. The for-display manual data generation unit 105 determines, on a chapter-by-chapter basis, whether or not the chapter can currently be made public, by referring to the records and the status data DJ. Next, the records of chapters that cannot be made public (i.e. are private) are excluded from the records narrowed down from the content page correspondence table TLA earlier (#314). Through this, the records are narrowed down to records of chapters that can be made public.

The content of page numbers indicated in the record is then extracted from the manual indicated in the narrowed-down records (#315). To be more specific, the chapter content data DS on the chapter contained in the page numbers is extracted from the manual data DM on the manual. Then, the for-display manual data DH is generated by merging the extracted chapter content data DS (#316). Note that data on a list of the narrowed-down records is included in the for-display manual data DH as data for a table of contents.

The for-display manual data transmission unit 106 then transmits the for-display manual data DH generated by the for-display manual data generation unit 105 to the terminal device 2 that is the source of the request (#317).

Returning to the terminal device 2, when the for-display manual data reception unit 204 receives the for-display manual data DH (#322), the display control unit 206 displays a table of contents (#323) such as that shown in FIG. 12, based on the list of data included in the for-display manual data DH. The content of the manual and chapter selected by the user is then displayed in the display 20c (#324).

According to the first embodiment, the portions of the manual appropriate for both the cooperative application executed by the terminal device 2 and the current status of the multi-function peripheral 1 can be selected from the manual of the multi-function peripheral 1 and provided to the terminal device 2. Accordingly, a user that is simultaneously using both the multi-function peripheral 1 and the cooperative application can easily refer to desired portions of the manual.

### Second Embodiment

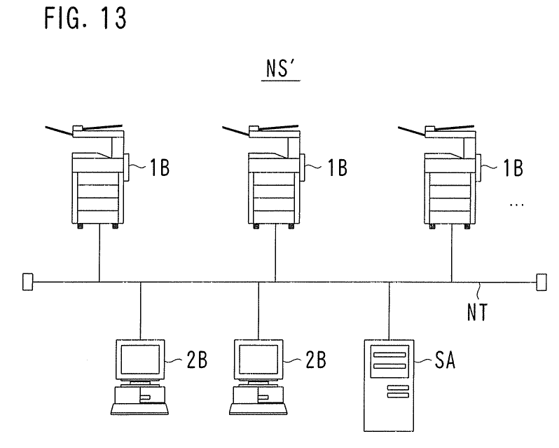

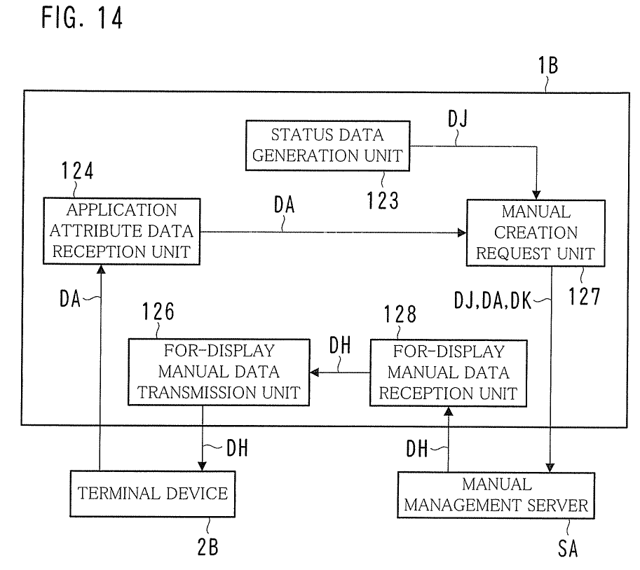

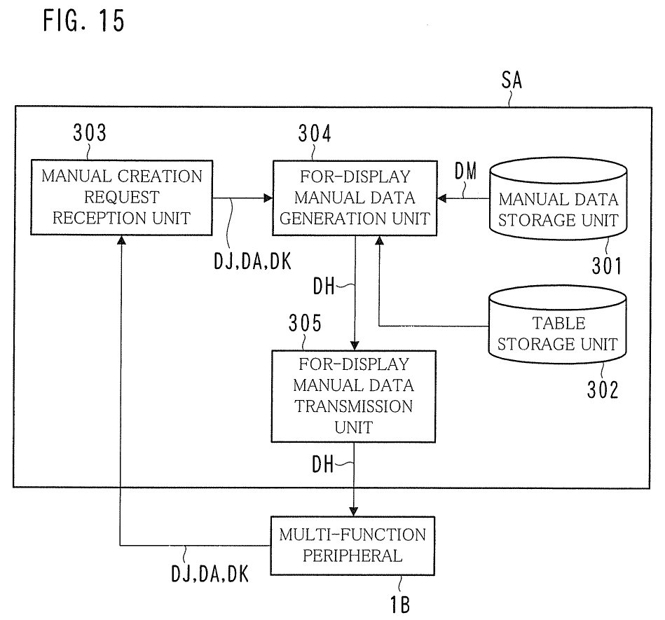

FIG. 13 is a diagram showing an example of the overall configuration of a network system NS′; FIG. 14 is a diagram illustrating an example of a functional configuration of a multi-function peripheral 1B; and FIG. 15 is a diagram illustrating an example of the functional configuration of a manual management server SA.

In the first embodiment, each multi-function peripheral 1 manages the manual data DM on its own manuals. However, in the second embodiment, a manual management server SA is provided in the network system NS′, and the manual data DM on each multi-function peripheral 1B is collectively managed by the manual management server SA, as shown in FIG. 13.

Hereinafter, the multi-function peripheral 1B, a terminal device 2B, and the manual management server SA shall be described, focusing on the differences between the first embodiment and the present embodiment. Descriptions of points common between the two embodiments shall be omitted.

The multi-function peripheral 1B is, as shown in FIG. 14, configured of a status data generation unit 123, an application attribute data reception unit 124, a for-display manual data transmission unit 126, a manual creation request unit 127, a for-display manual data reception unit 128, and so on.

The status data generation unit 123, application attribute data reception unit 124, and the for-display manual data transmission unit 126 respectively perform essentially the same processes as the status data generation unit 103, the application attribute data reception unit 104, and the for-display manual data transmission unit 126 of the first embodiment, shown in FIG. 3.

Comparing FIG. 14 with FIG. 3, it can be seen that the multi-function peripheral 1B is not provided with functions equivalent to the manual data storage unit 101, the table storage unit 102, and the for-display manual data generation unit 105 of the first embodiment. The functions equivalent to those units are instead provided in the manual management server SA. In other words, the manual management server SA is caused to manage the manual data DM and generate the for-display manual data DH.

Meanwhile, the manual creation request unit 127 and the for-display manual data reception unit 128, which take on the role of an interface with the manual management server SA, are provided in the multi-function peripheral 1B.

The manual management server SA is, as shown in FIG. 15, provided with a manual data storage unit 301, a table storage unit 302, a manual creation request reception unit 303, a for-display manual data generation unit 304, and a for-display manual data transmission unit 305.

The manual data storage unit 301 and the table storage unit 302 respectively fulfill the same basic roles as the manual data storage unit 101 and the table storage unit 102 of the multi-function peripheral 1 shown in FIG. 3. However, if there are plural models of multi-function peripherals 1B provided in the network system NS′, manual data DM is stored on a manual-by-manual basis for each model of multi-function peripheral 1B. Furthermore, the content page correspondence table TLA (see FIG. 6) and the content publication settings table TLB (see FIG. 7) are also stored in the table storage unit 302 on a model-by-model basis.

The for-display manual data generation unit 304 performs the same process as the for-display manual data generation unit 105 of the multi-function peripheral 1 described in the first embodiment. In other words, the for-display manual data generation unit 304 generates the for-display manual data DH.

The functional configuration of the terminal device 2B is identical to the functional configuration of the terminal device 2 of the first embodiment, shown in FIG. 5.

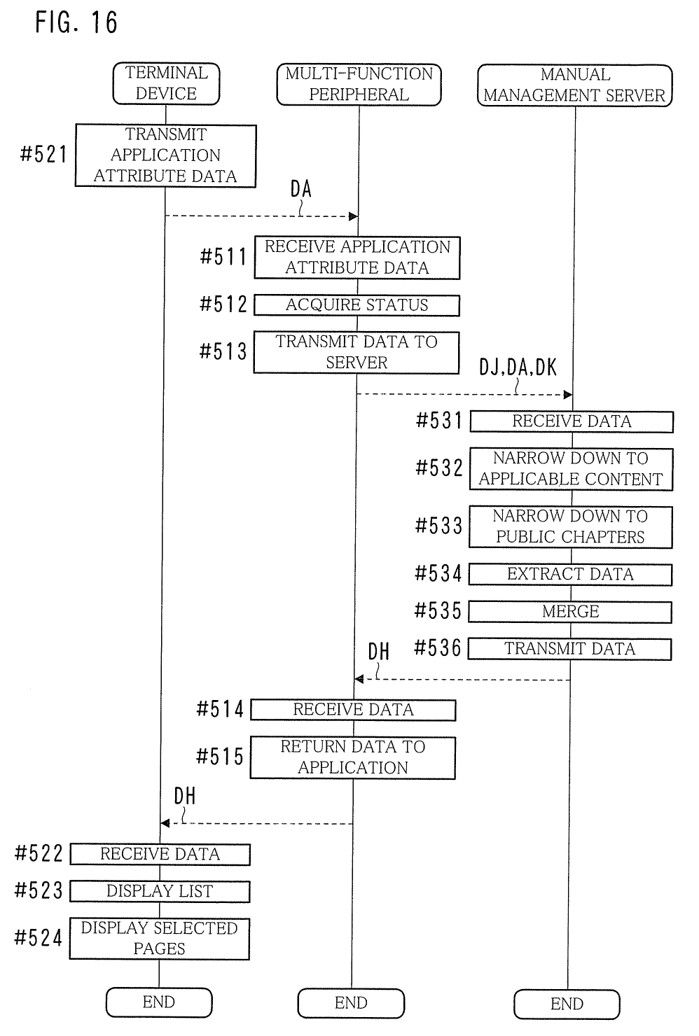

FIG. 16 is a flowchart illustrating an example of the flow of processing for requesting, generating, and distributing a manual.

Next, details of the processes performed by the various constituent elements of the multi-function peripheral 1B and the manual management server SA shall be described with reference to FIG. 16.

Upon the terminal device 2B transmitting the application attribute data DA to the multi-function peripheral 1B (#521) and the application attribute data reception unit 124 of the multi-function peripheral 1B receiving that data (#511), the status data generation unit 123 generates the status data DJ (#512), and the manual creation request unit 127 requests the manual management server SA to create the for-display manual data DH (#513).

At this time, the manual creation request unit 127 transmits the received application attribute data DA, the generated status data DJ, and model identification data DK indicating the model of the multi-function peripheral 1B itself are transmitted to the manual management server SA.

When the manual creation request reception unit 303 of the manual management server SA receives the application attribute data DA, the status data DJ, and the model identification data DK along with the request to create a manual (#531), the for-display manual data generation unit 304 generates the for-display manual data DH using the content page correspondence table TLA (see FIG. 6) and the content publication settings table TLB (see FIG. 7) for the model indicated in the model identification data DK, and the application attribute data DA and model identification data DK received with the manual data DM (#532 to #535). The generation method is the same as-that described in Steps #313 to #316 in FIG. 11.

The for-display manual data transmission unit 305 then transmits the generated for-display manual data DH to the multi-function peripheral 1B, which is the source of the request (#536).

When the for-display manual data reception unit 128 of the multi-function peripheral 1B receives the for-display manual data DH from the manual management server SA (#514), the for-display manual data transmission unit 126 transfers (transmits) that data to the terminal device 2B, which is the source of the request (#515).

As with Steps #322 to #324 in FIG. 11, the terminal device 2B displays pages from the manual as appropriate based on the received for-display manual data DH (#522 to #524).

According to the second embodiment, the efficiency with which the manuals of the multi-function peripherals 1B that configure the network system NS′ are managed can be improved.

In the first embodiment and the second embodiment, the terminal device 2 acquires the for-display manual data DH from the multi-function peripheral 1 upon the user performing an operation to refer to a manual. However, this acquisition may be carried out at a different timing. For example, the acquisition may occur when a cooperative application is started. Alternatively, the acquisition may occur when a malfunction has occurred in the cooperative application or the multi-function peripheral 1.

In the first embodiment and the second embodiment, the multi-function peripheral 1 transmits all content applicable to the current statuses of the cooperative application and the multi-function peripheral 1 to the terminal device 2. However, the multi-function peripheral 1 may instead provide only the table of contents at first. Content corresponding to chapters or pages may then be transmitted to the terminal device 2 as those chapters or pages are selected from the table of contents, in the same manner as online help services provided by a web server.

In the first embodiment and the second embodiment, the concept of a “chapter” was used to describe the groups that make up a single manual. However, this concept may be referred to as a “section” or an “item” instead.

In the first embodiment and the second embodiment, the example described is one in which the manual of the multi-function peripheral is provided. However, the present invention is also applicable for providing the manuals of a peripheral device aside from the multi-function peripheral, such as, for example, a card reader, a scanner, a server hard disk, a printer, or the like.

Various modifications may be made to the overall or partial configurations of the network systems NS and NS′, the multi-function peripherals 1 and 1B, the terminal devices 2 and 2B, and the manual management server SA, the configuration and details of the tables, the configuration and details of the screens, the details of the data, the details and order of the processes performed by the various devices, and so on without departing from the essential spirit of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A manual provision method for providing a manual of a peripheral device to a user, the method comprising:
a first step of causing a computer used by the user to transmit, to the peripheral device, application identification information on an application used along with the peripheral device by the computer; and
a second step of causing the peripheral device to transmit, to the computer, content data indicating content of the manual that corresponds to the application indicated by the application identification information received from the computer.

2. The manual provision method according to claim 1,
wherein the manual is configured of a plurality of groups;
a saving portion that saves group content data on each of the groups of the content in association with group content data identification information on the group content data, and a storage portion that stores the group content data identification information on the group content data in association with the application identification information on the application to which the group content data corresponds, are provided; and
in the second step, the peripheral device is caused to transmit, to the computer, the group content data saved in the saving portion in association with the group content data identification information stored in the storage portion in association with the application identification information received from the computer.

3. A manual provision method for providing a manual of a peripheral device to a user,
wherein a saving portion that saves, per group that configures the manual, content data indicating content of the group in association with content data identification information on the content data, and a storage portion that stores the content data identification information on the content data in association with application identification information on an application used along with the peripheral device by a terminal device corresponding to the content data, are provided in a server connectable to the peripheral device via a communication line,
the method comprising:
a first step of causing a terminal device used by the user to transmit, to the peripheral device, application identification information on an application used along with the peripheral device by the terminal device;
a second step of causing the peripheral device to transmit, to the server, the application identification information received from the terminal device;
a third step of causing the server to transmit, to the peripheral device, the content data saved in the saving portion in association with the content data identification information stored in the storage portion in association with the application identification information received from the peripheral device; and
a fourth step of causing the peripheral device to transmit, to the terminal device, the content data received from the server.

4. A manual provision method for providing a manual of a peripheral device to a user, the method comprising:
a first step of causing the peripheral device to determine the current status of the peripheral device itself; and
a second step of causing the peripheral device to transmit, to a computer used by the user, content data on the manual corresponding to the current status of the peripheral device itself as determined in the first step.

5. The manual provision method according to claim 4,
wherein the manual is configured of a plurality of groups;
a saving portion that saves group content data on each of the groups of the content in association with group content data identification information on the group content data, and a storage portion that stores the group content data identification information on the group content data in association with a status of the peripheral device to which the group content data corresponds, are provided; and
in the second step, the peripheral device is caused to transmit, to the computer, the group content data saved in the saving portion in association with the group content data identification information stored in the storage portion in association with the current status determined in the first step.

6. A manual provision method for providing a manual of a peripheral device to a user,
wherein a saving portion that saves, per group that configures the manual, content data indicating content of the group in association with content data identification information on the content data, and a storage portion that stores the content data identification information on the content data in association with a status of the peripheral device that corresponds to the content data, are provided in a server connectable to the peripheral device via a communication line,
the method comprising:
a first step of causing the peripheral device to determine the current status of the peripheral device itself;
a second step of causing the peripheral device to notify the server of the current status of the peripheral device itself as determined in the first step;
a third step of causing the server to transmit, to the peripheral device, the content data saved in the saving portion in association with the content data identification information stored in the storage portion in association with the current status as notified by the peripheral device; and
a fourth step of causing the peripheral device to transmit, to a computer used by the user, the content data received from the server.

7. A peripheral device that is connected to a computer and used, the peripheral device comprising:
an application identification information reception portion that receives, from the computer, application identification information on an application used along with the peripheral device by the computer; and
a content data transmission portion that transmits, to the computer, content data indicating content of a manual of the peripheral device corresponding to the application indicated by the application identification information received by the application identification information reception portion.

8. The peripheral device according to claim 7, further comprising:
a saving portion that saves group content data on each of a plurality of groups of the content in association with group content data identification information on the group content data; and
a storage portion that stores the group content data identification information on the group content data in association with the application identification information on the application that corresponds to the group content data,
wherein the content data transmission portion transmits, to the computer, the group content data saved in the saving portion in association with the group content data identification information stored in the storage portion in association with the application identification information received from the computer.

9. A peripheral device that is connected to a computer and used, the peripheral device comprising:
a status determination portion that determines the current status of the peripheral device itself; and
a content data transmission portion that transmits, to the computer, content data on a manual corresponding to the current status as determined by the status determination portion.

10. The peripheral device according to claim 9, further comprising:
a saving portion that saves group content data on each of a plurality of groups of the content in association with group content data identification information on the group content data; and
a storage portion that stores the group content data identification information on the group content data in association with a status of the peripheral device corresponding to the group content data,
wherein the content data transmission portion transmits, to the computer, the group content data saved in the saving portion in association with the group content data identification information stored in the storage portion in association with the current status as determined by the status determination portion.

11. A computer program product for controlling a peripheral device that is connected to a computer and used, the computer program product causing the peripheral device to execute:
a first process of receiving, from the computer, application identification information on an application used along with the peripheral device by the computer; and
a second process of transmitting, to the computer, content data indicating content of a manual of the peripheral device corresponding to the application indicated by the received application identification information.

12. The computer program product according to claim 11,
wherein the peripheral device is provided with a saving portion that saves group content data on each of a plurality of groups of the content in association with group content data identification information on the group content data, and a storage portion that stores the group content data identification information on the group content data in association with the application identification information on the application to which the group content data corresponds; and
a process of causing the peripheral device to transmit, to the computer, the group content data saved in the saving portion in association with the group content data identification information stored in the storage portion in association with the application identification information received from the computer, is executed as the second process.

13. A computer program product for controlling a peripheral device that is connected to a computer and used, the computer program product causing the peripheral device to execute:
a first process of determining the current status of the peripheral device itself; and
a second process of transmitting, to a computer used by the user, content data on a manual corresponding to the current status of the peripheral device itself as determined in the first process.

14. The computer program product according to claim 13,
wherein the manual is configured of a plurality of groups; and
the peripheral device is provided with a saving portion that saves group content data on each of the groups of the content in association with group content data identification information on the group content data, and a storage portion that stores the group content data identification information on the group content data in association with a status of the peripheral device to which the group content data corresponds, and
the computer program product causes the peripheral device to execute:
a process of transmitting, to the computer, the group content data saved in the saving portion in association with the group content data identification information stored in the storage portion in association with the current status determined in the first process, as the second process.
